(19) United States
(12) Patent Application Publication
(10) Pub. No.: US 2011/0038594 A1
(43) Pub. Date: Feb. 17, 2011

(54) Handheld recorder incorporating true raw audio or video certification

(76) Inventors: Gary M. Symons, Kelowna (CA); Kirk David Symons, Kelowna (CA); David Allan French, Kelowna (CA); Paul Mark Toupin, Kelowna (CA)

Correspondence Address: Horsepower Intellectual Property Law, Unit 206-3500 Carrington Road, Westbank, BC, V4T 3C1, CA

(21) Appl. No.: 12/736,637

(22) PCT Filed: Apr. 27, 2009
(86) PCT No.: PCT/CA2009/000536

§ 371 Date: Oct. 25, 2010

Related U.S. Application Data
(60) Provisional application No. 61/071,391, filed on Apr. 25, 2008.

(51) Int. Cl. H04N 5/77

(52) U.S. Cl. 386/224; 386/E05.069

(57) ABSTRACT

A method and apparatus for recording audio or video data so as to enable true raw audio or video certification includes recording on a mobile recorder an audio or video data stream taken from at least one microphone or camera respectively cooperating with the recorder, generating a digital hash and embedding the digital hash in the data stream concurrently with the recording of the data stream, enabling playback of the recording containing the digital hash by a playback device not equipped to decode the digital hash, wherein the digital hash contains attributes unique to the recording and where the digital hash is embedded in the data stream so as to minimize noise impact on a later playback of the data stream respectively by the playback device, and wherein the digital hash is embedded during the embedding continuously on a periodic basis throughout the duration of the recording.

### FIELD OF THE INVENTION

This invention relates to the field of handheld recorders and systems incorporating same, providing the means to edit audio and video on the same mobile, handheld device, and providing methods of certifying the authenticity of recorded audio and video data.

### BACKGROUND OF THE INVENTION

There are many industries and individuals with a need for portable devices to record audio and video. They include, but are not limited to: the broadcast industry; law enforcement; security and private investigation companies; musicians; podcasters; insurance companies; law firms; physicians and psychiatrists; court reporters; and students of all kinds.

There are currently many portable recorders on the market, including some with stereo recording capability, but they do not allow sophisticated editing of the recorded data; they do not have means or methods of authenticating the recorded data, and they do not allow the collected data to be transmitted wirelessly to another device.

There are also four designs on the market that combine recording software, with an external microphone, used with a wireless handheld phone that also serves as a mobile computing device, described here as a ‘smartphone’. Those devices include: The PocketRec™ from the United States; the PocketRekorder™ from Austria; the Luci™ from the Netherlands; and a modified version of the Nokia N95™ smart phone from Finland, equipped with an adapter to allow an external microphone to be attached. The first three of these devices allow basic audio editing. The adapted Nokia N95 allows video recording.

Further problems with the prior art devices that currently exist are a) that whenever you deal with a mobile wireless device you have to deal with radio frequency interference or electromagnetic interference and this can cause severe degrading of the audio recording especially; and, b) there is a lack of ubiquity in the design of accessories meant to connect to smartphones and other mobile devices. For example there are a number of microphones that are hooked up to smart phones or other similar devices but they can only be used with that specific device. A microphone for an IPhone™ generally only works with an IPhone™. A microphone designed for a Nokia Smart Phone™ generally only works with Nokia Smart Phone™. The more sophisticated the recording device the more true that is. Each device has its own operating system, its own ports or electronic connections and this makes ubiquity a difficult problem. For example, the Alesis™ recorder acts likes a holster for an IPhone™ or IPod Touch™ MP3 player. The IPhone™ or IPod Touch™ slips into the holster so as to provide a stereo recording device. In essence what is being added is a pair of microphones. However that recording device cannot be used with any other brand of smartphone. It is one object of the present invention to attempt to solve the ubiquity problem.

The prior art smart phones or other mobile wireless devices require that the microphone or the recording device must be physically connected to the smartphone. This creates a number of problems. In some cases you may want to separate them physically so you can monitor your recording from a distance. Also, by separating them you actually reduce or eliminate the RF (radio frequency) interference. On the issue of separating the devices and wirelessly transferring audio and/or video back to the smartphone. It would be advantageous to be able to stream that audio or video data and it is an object of one embodiment of the present invention to so provide from the recording unit back to a smartphone for monitoring purposes. This could be done wirelessly, for example but not limited to, using Bluetooth™ or Wi-Fi.

None of the above mentioned prior art devices provide the means or methods to verify the authenticity of the raw source recording, and they may not be able to change in post recording the audio quality that they have gained. It is another objective of the present invention to add a system to be able to improve audio quality or the focus of the audio direction in the post process, that is in editing. It is an object of the present invention to accomplish the latter through being able to change the direction in which the sound is chosen to come from and also through noise cancellation. If there is a noise in the background somewhere during the recording, that background noise may be removed.

Another drawback in the prior art is that presently there is the lack of accessible processing power in a smart phone or a similar small mobile wireless devices to actually do the required editing of audio and video within the handheld device. Although there are fairly powerful processors in some of these smart phones, for example the IPhone™ 3G uses an Arm 9™ processor and has 128 megs of RAM—most of that processing power is taken up by the operating system of the device and very little of it is left over to complete the kind of processor intensive audio and video processing that is required in the present invention. For example, while the IPhone™ has 128 megs of RAM, operationally usually only somewhere between 10-25 megs of RAM is available for processing.

In the prior art, applicant is also aware of U.S. Pat. No. 6,091,816 which issued to Woo on Jul. 18, 2000, for an Integrated Audio Recording and GPS System wherein Woo describes a method and apparatus for providing a time stamp and for integrating location information with audio input signals which are stored on recording media. As taught by Woo, the position information which may be obtained from a satellite-based radio navigation system such as the global positioning system (GPS), is automatically recorded or embedded as part of corresponding audio information digitally recorded by a portable audio recording device. As disclosed by Woo, the original digitally recorded audio is re-formed as a modified digital recording, now containing the position information recorded at the time the original audio information was digitally recorded. The integrated digital information containing both audio and position information is stored in the portable audio recording device, and in doing so, any attempt to modify or alter the recorded position information also results in a corresponding modification or alteration of the recorded audio information. Woo further teaches that the information can be encrypted.

In the prior art the applicant is further aware of U.S. Pat. No. 7,184,573 which issued Feb. 27, 2007 to Malone et al for an apparatus for capturing information as a file and enhancing the file with embedded information. Malone et al teach recording an image or other data in real time using a capture device for capturing the image or other data, and once so captured, using a local verification device to indelibly mark the captured image or other information with a representation of date, time, location and information identifying the creator. Malone et al disclose that a video segment, a still picture or an audio segment may be stored in a secured and certifiable manner such that it is non-repudiatable. Further, Malone et al disclose that the capture device may be a cell phone for capturing for example an audio file and for capturing and digitizing an image or video segment. The GPS system is used as a trusted entity to provide verification including a time stamp and a longitude and latitude and that the information may be embedded into the captured file or image as for example a watermark so that the result is that the document, file image, etc is indelibly marked with the date, time and the location, in addition to associating therewith information about the user in the form of a user ID. Malone et al further teach that the file is compressed and encrypted and then subjected to a certification process from a trusted third party certification authority to provide a level of authenticity to the file. Further, Malone et al discuss the use of metadata and state that anyone knowledgeable in the field can modify the metadata to make the images, video, audio and photographs appear that they were taken at a time and place other than the real time and place.

Malone teaches that an audio recording can be marked, or more properly ‘watermarked’ with embedded metadata in a process known as ‘steganography’, which is the practice of embedding secret, encrypted digital data into a data stream, that can only be unlocked and viewed by those with the proper encryption ‘key’. Malone teaches that, in order to authenticate a multimedia file, such as a still image, video, or audio, one can use GPS time and location data as a way to verify the said data. However, Malone's invention differs from the present invention as described below. For example Malone uses it to ‘hide’ or lock away the digital data in a secure storage facility, “wrapped in a first layer of encryption, and a second layer of encryption”. In order to access the file, according to the teaching of Malone the user must “have the private key to unwrap the first layer and the other key to unwrap the second layer” before the file can be viewed or used. Malone teaches that one can use GPS data, device data, and other similar data, in order to encrypt and limit the use of the digital file.

### SUMMARY OF THE INVENTION

The present invention includes a high-quality audio and video recorder, with completely integrated electronics for the recording and multitrack editing of studio quality sound, and sharp video and synergistically cooperating with the functionality normally associated with a smart phone or personal digital assistant (PDA) collectively herein a “smart phone”.

The device according to one aspect of the present invention, provides users with a completely integrated device that can record the full range of sound within the human hearing spectrum, and also record that sound, and verify that the sound was recorded at a certain place, at a certain time, by a certain person. The importance of this can be illustrated by the example of a musician recording a new song, and using that recording to establish his or her intellectual property rights.

The Recorder of the present invention is primarily a handheld recording/editing device, which cooperates with a wireless smart-phone. The integrated design of the Recorder consists of a mixture of hardware and software or firmware elements.

The design may include a phased array of microphones placed so as to record a sound envelope in separate directions toward and away from the four opposite corners by the device so as to envelope the user. In one embodiment a video camera is mounted on a rotating axis or otherwise in such a way that it may be rotated 180 degrees so as to point towards the user holding the device or away from the user. It may also include a pre-amplifier; a high-quality sound card; and, an analog to digital converter to convert the analog sound to a digital signal, a processor, random access memory (RAM), and storage memory such as flash or other memory whether permanently resident and/or in a removable media.

Advantageously the present invention is a system of both the Recorder and the corresponding smartphone. The smartphone contains application software according to the present invention which converts the smartphone into a wirelessly connected user interface with, and remote control for, the Recorder. An audio and video editing suite is included as part of the software, with the audio and video editing processing tasks taking place preferably in the Recorder, but with the editing decision being communicated from a user interface on the smart phone. A recording program is linked directly to the array of microphones, through the Analog to Digital Converter. True Raw Audio Certification and a True Raw Video Certification software is included. The touch screen of the smartphone is used to control the functions of the Recorder and smartphone, including to edit audio and video.

The invention in various other of its aspects provides a sophisticated audio and video recording device, that may also allow the user to:
a) record audio and video, with higher audio quality than is currently possible using a device of this nature;
b) edit recorded content;
c) send the content over the internet to another user;
d) embed authentication data into the audio and video recording, and verify authentication of previously recorded audio and video data, using TRAC and TRVC;
e) combine audio and video;
f) share video and/or audio conference calls with very high-quality audio;

In summary the present invention may be characterized in one aspect as including a method and apparatus for recording audio or video data so as to enable true raw audio or true raw video certification wherein the method includes the steps of, and the apparatus includes means for:
a) recording on a mobile recorder an audio or video data stream taken from at least one microphone or camera respectively cooperating with the recorder,
b) generating a digital hash and embedding the digital hash in the data stream concurrently with the recording of the data stream,
c) enabling playback of the recording containing the digital hash by a playback device not equipped to decode the digital hash,
wherein the digital hash contain attributes unique to the recording and wherein the digital hash is embedded during the embedding in the data stream so as to minimize noise impact on a later audio or visual playback of the audio or video data stream respectively by the playback device, and wherein the digital hash is embedded during the embedding continuously on a periodic basis throughout the duration of the recording.

In preferred embodiment the digital hash is embedded in a least significant bit of the data stream, and the digital hash includes value representations of attributes chosen from the group which may include a location of the recording, the time of the recording, the duration of the recording, an identification code of a device used to make the recording, the date of the recording, user ID. Advantageously the value representations of the attributes are meta-data. The digital hash may be a unique numeric data sequence. The attributes may provide a key enabling generating of the digital hash. Further advantageously, the embedding of the digital hash introduces an audibly imperceptible amount of the noise to the recording.

The method may further include the steps of recording the attributes in a non-encrypted retrievable format in the recording so as to be retrievable by the playback device, and the decoding the digital hash and determining the status of the certification of the recording by comparing the recording of the attributes in the non-encrypted format with the attributes from the digital hash, and if the comparison determines no difference between both encrypted and non-encrypted attributes then certifying the recording as being an unaltered recording.

Yet further advantageously the method further includes the step of and the apparatus includes the means for breaking up the recording into a plurality of contiguous sequential segments and regenerating the digital hash for each segment in at least a sequential subset of the sequential segments.

In one embodiment the method includes, and the apparatus includes means for, embedding an analog attribute into the recording continuously throughout the duration of the recording, advantageously within an audible range in the recording.

In a preferred embodiment the recording device is adapted to work with different types of smartphone platforms, without the necessity of creating a physical, electronic point of connection for each of the different types of smartphone platforms. This may include means for reducing RF interference with audio recording in proximity to the smartphone or as a mobile phone cooperating with the device by providing a shielded microphone and at least one non-shielded microphone for making the recording, and using the signal from the shielded microphone to filter the RF interference from the recording so to provide noise elimination. In a preferred embodiment the at least one non-shielded microphone is a phased array of microphones and wherein an audio envelope is recorded by the phased array, and wherein the method further includes the step of shaping the audio envelope. The phased array of microphones provides for separating the microphones from the mobile phone cooperating with the device by use of a form factor to minimize RF interference.

### BRIEF DESCRIPTION OF THE DRAWINGS

In the drawings forming part of this specification, and wherein that similar characters of reference denote corresponding parts in each view:

FIG. 1 is a diagrammatic representation of a recorder according to the present invention communicating with a smartphone during a recording.

FIG. 2a is, in front elevation view, the recorder of FIG. 1.

FIG. 2b is, in left side elevation view, the recorder of FIG. 2a, showing the recorder mounted in a phone case, and the smart phone in the case.

FIG. 2c is, in top view, the recorder of FIG. 2a.

FIG. 2d is, in bottom view, the recorder of FIG. 2a.

FIG. 2e is the view of FIG. 2b diagrammatically illustrating a sound envelope around the head of the recorder.

FIG. 3 is, in isometric wire-frame view, the recorder of FIG. 2a.

FIG. 4 is a diagram showing the components of the recorder according to the present invention.

FIG. 5 is a flow chart of one embodiment of TRAC implementation according to the present invention.

FIG. 6 is a table illustrating the components of a WAV file.

FIG. 7 is an example of a screen view during editing of a recording using the phone screen according to the present invention.

FIG. 7a is an enlarged view of the screen of FIG. 7.

### DETAILED DESCRIPTION OF EMBODIMENTS OF THE INVENTION

The current invention is designed to allow a user to record high( )quality audio and video on a device connected wirelessly or physically to a smartphone or other mobile computing device; to create edited versions of said audio and video recordings through a combination of the recording device and a smartphone-based under interface; to easily transmit the recorded data from the smartphone to another computing device over the internet, for example but not limited to using Wi-Fi, or the cellular network; and to easily verify whether the original recorded audio and/or video data has been altered or edited in any way.

In the following discussion, the term “TRAC” will be used interchangeably for either true audio certification (TRAC), or true video certification (TRVC).

In contra-distinction to the prior art, in the present invention when true raw audio certification (TRAC) or true raw video certification (TRVC), collectively also referred to herein as “TRAC”, enabled audio recordings are played on any compatible device (such as a WMA player), the complete audio will be clearly audible to the listener. And the complete video will be viewable by the viewer, the system does not restrict access to the audio and video content in any way; nor does it prevent someone from editing that content if they so wish. The main purpose of TRAC is to authenticate or certify that the original audio or video file, and unedited, intact copies of same, have never been edited or altered in any way.

The audio data can also be copied, edited, and used in any way without restriction. However, when played on any TRAC-equipped device, the TRAC-equipped device will show whether or not the audio has been copied, edited, or altered in any way. And, while any TRAC-equipped device may view the metadata which ensures verification of the audio record, no device or person, including the original user, will be able to unlock the encrypted verification data; so that no person, including the original user, will be able to change the audio record, without that change being detected by any other TRAC—enabled device. This is done because the audio data will carry forward a watermark showing where, when, and on what device the original recording was created on.

Also in contra-distinction of the prior art, in one embodiment of the present invention does not only use digital watermarking, as in the teachings of Malone, or Woo, but, rather, a combination of digital and analog watermarking, in a unique scheme of stegnoraphy, both Malone and Woo disclose a scheme of using digital data only, comprising primarily the geo-location data, temporal data, and perhaps device identification data, to create a digital watermark on the audio or video file. The present invention strengthens digital encryption by a system of audio analog encryption, described in more detail below. The essence of this system is that the system will emit a series of low-level “chirps”, being sounds that cross through wide portions of the audio spectrum, and that these chirps will be emitted in a pattern that can be detected by the TRAC device. If the recording is changed, then the pattern of chirps will likewise be changed.

In addition, the chirps may be generated in such a way that they can be interpreted as binary code. This audio system of binary code will communicate a message confirming the encrypted geo-location, temporal and device identification information used in the digital watermark.

The end result is that any change to the audio-video record will create a secondary inconsistency in the analog data, which will be instantly detectable by the TRAC device, or even, in some cases, by the human ear.

A further difference from the teachings of Malone and Woo is that the present device includes a system of editing in which it is not possible to alter or edit the original audio and video recording. This system allows the user to create edits by selecting and copying sections or “clips” from the original audio and video recording.

The system only allows users to copy clips from original recordings, and allows no provision for altering the original recording. In the present invention TRAC will in some embodiments work in conjunction with this type of editor, in order to ensure that audio-visual recordings are preserved in their original state, while allowing users to easily create edited versions of that digital content.

Using the example of a reporter editing a story for broadcast, the present invention would allow the reporter to create clips or entire copies of the audio or video record, and to create heavily edited versions of that record. It would also allow the reporter to transmit the entire original record to another device, and to edit it on that device. However, in such a case it would note that the audio or video data had been altered, and at what point in the recording the alteration had taken place. It may also, in one version of the current invention, preserve an ‘original’ of the recording, which could not be edited, deleted or changed, without the user's private encryption key.

In this way, the present invention provides a portable recording device that verifies the unaltered accuracy of recorded speech or sounds, and in one embodiment also video, and yet still makes this data fully available to anyone who wishes to use it, and to create edited versions of that data. As well, anyone with a TRAC-equipped device would also be able to view the TRAC verification data, but could not alter it or delete it. In this way, the present invention provides secure verification of audio data, but without limiting public use of the data.

Similar to Malone et al., Woo similarly teaches that GPS and other time/location data can be used to insert metadata into an audio recording made by a portable device. Woo further teaches that this GPS or other time/location data can be used to encrypt the resulting audio data file in such a way that it is secure from use by unauthorized persons, and also may not be altered or deleted.

Woo instructs that “once the digital frame is formed, this frame may be frozen within recording media of portable recording device so that integrated digital information cannot be altered or deleted in any way, but can be audibly displayed or can be downloaded and processed by an authorized downloader to exhibit the audio and the corresponding position information for authentication. The chain of custody of the image is preserved and is not compromised through custody of the portable audio recording device and its stored audio information. In the present invention the integrated digital information and authentication information is never transmitted to another person or facility and thus is not transmitted to another person or facility and thus is not imperceptible or vulnerable to deletion or alteration by a person or facility with an incentive to make such deletions or alterations.

The present invention allows the transmission and copying of the audio/video recording, and even the editing or alteration of that data, or even the deletion of that data. However, it uses encrypted metadata, including but not limited to the location/time information, to create a system whereby the alteration or copying of the audio record cannot be done without being detected by a TRAC-enabled device. Any tampering of the recording renders the integrity of the recording null, and the result will not be a “TRAC file.”

Woo teaches that “alteration of the said positioning information stored on said recording media results in alteration of corresponding audio input signals stored on said recording media”. By contrast, the present invention does not alter the audio signals if they have been edited or copied. The purpose of the TRAC device according to the present invention is to maintain the audio recording for public use. Woo's instructions are aimed at limiting use of the audio information, while it is an object of the present invention to allow full use of the audio information, but while always maintaining the ability to ascertain the integrity of the original recording.

As stated above there are many instances in which it would be beneficial to have the ability to record audio or video on a mobile device, and preferably a handheld mobile device, which is high-fidelity stereo sound using true raw audio certification (TRAC). In one example, this could be used for example, in the legal community, for taking the evidence of witnesses and deponents giving their testimony under oath which presently is laboriously provided using expensive court reporters and in which the turn-around time is often significantly delayed while transcripts are prepared by the court reporters. Other useful examples are set out above.

### Preferred Physical Embodiment

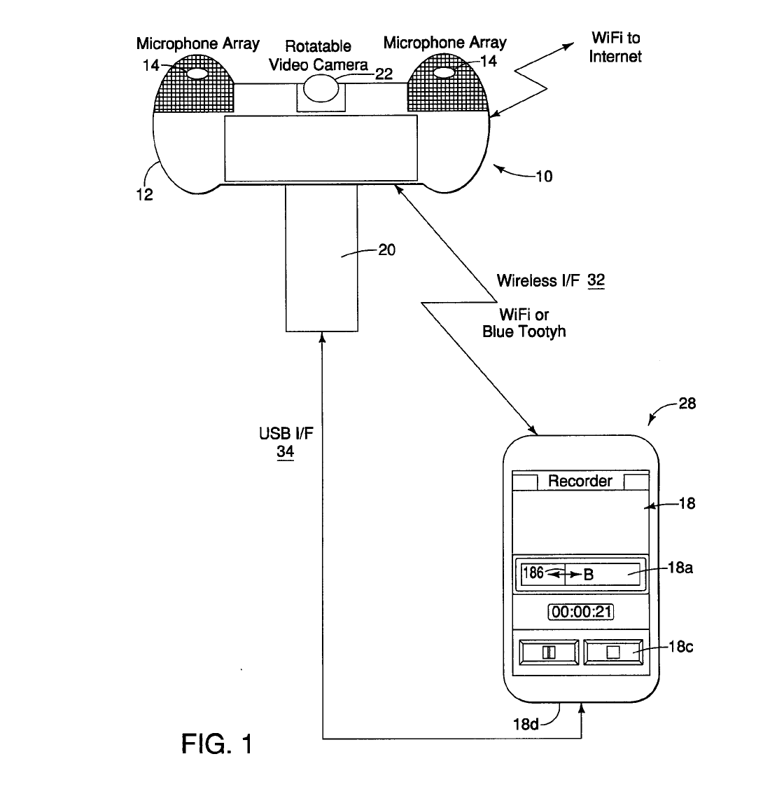

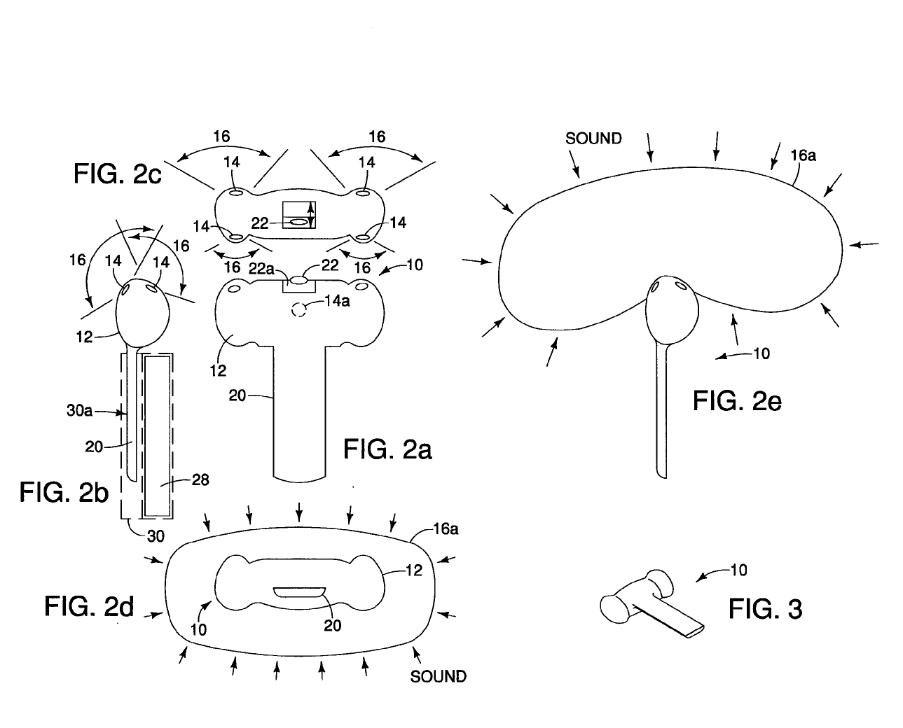

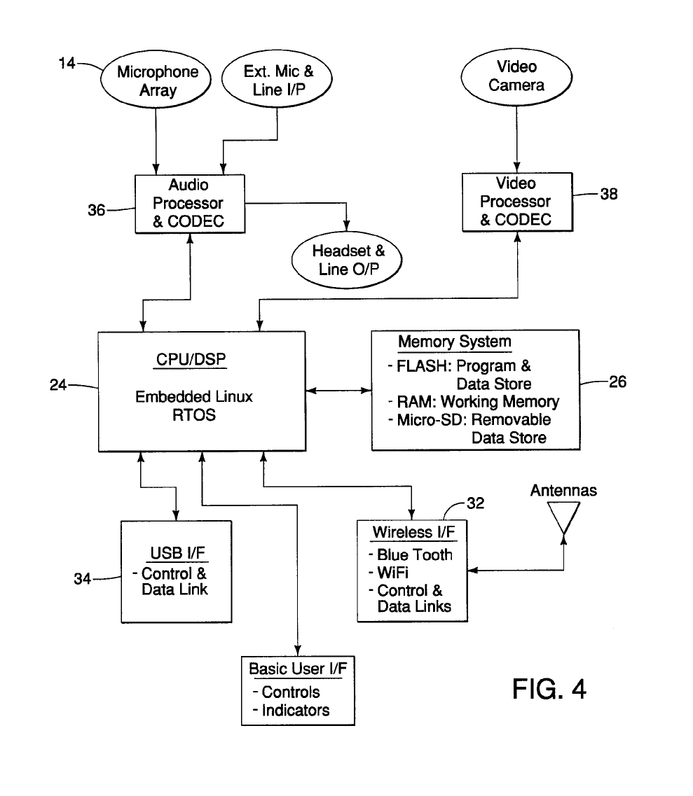

As seen in FIGS. 1 and 2a-2e the present invention provides in one embodiment, which is not intended to be limiting, a handheld recording/editing device 10, alternatively referred to as an external device 10 which may be wirelessly piggy-backed on a personal digital assistant and/or a smart phone as better described below, so as to provide maximum efficiency in the devices required to be carried by a user such as an investigative reporter, lawyer, or the like. Thus the handheld external device 10 may have a head 12. Device 10 has a spaced apart array of microphones 14, for example, a phased array of four electret microphones 14, one in each opposite corner, covering a field 16 of substantially 360 degrees around the device or so as to capture a sound envelope 16a (shown diagrammatically and not to scale the illustrations) around the user. As seen in the accompanying illustrations, the microphones may be mounted on opposite corners at opposite ends of the head 12 of device 10.

Device 10 includes a base such as for example a bayonet-style battery housing 20 for removably mounting device to a handheld smart phone 28 in the scabbard 30a of a phone case 30, (shown in dotted outline). The functions according to the present invention as described herein, including, high fidelity recordings by a phased array of microphones, TRAC and TRVC using metadata streams embedded throughout the length of a recording, hand-held editing, etc., are performed by a processor 24 and memory unit 26 mounted in head 12.

Head 12 may be in the shape of a hammer head. This is not intended to be limiting. Head 12 may be shaped like the head of a hammer head shark. The base may be a handle or bayonet-shaped that either may be held by the user or slid down into the scabbard 30a of an adapted cell phone case 30 that is adapted for whatever phone 28 a user may have. The four microphones 14 allow collection and recording of sound from all directions. Later on during processing or editing of the recording the desired noise envelope may be tailored. Thus to accentuate sound from one direction only or opposite directions or to define a sound beam, the sound envelope 16a may be tailored in post-processing. Advantageously a fifth shielded microphone 14a (shown in dotted outline) embedded in head 12 is used to allow some noise reduction, both of radio frequency interference and also electromagnetic interference.

The fifth microphone 14a is built-in to the head and adapted in it's own housing so that it is shielded from audio; that is, so it is not picking up all of the common noise from the other microphones, but is going to pick up the radio frequency interference and the electromagnetic interference which is going to be common to the other microphones. That RF and electromagnetic interference is then subtracted in firmware from the signals experienced by the other microphones so as to eliminate that noise. This substantially gets rid of the unwanted sound. This is important in this particular context in that any smart phone is going to emit dramatic radio frequency interference noise into a recording, and that has been one of the greatest drawbacks for any recording device connected to a smart phone. Conventionally what this presently means is that whenever a user wants to record the user has had to turn their smart phone RF device off, in other words, go into an “airplane” use mode.

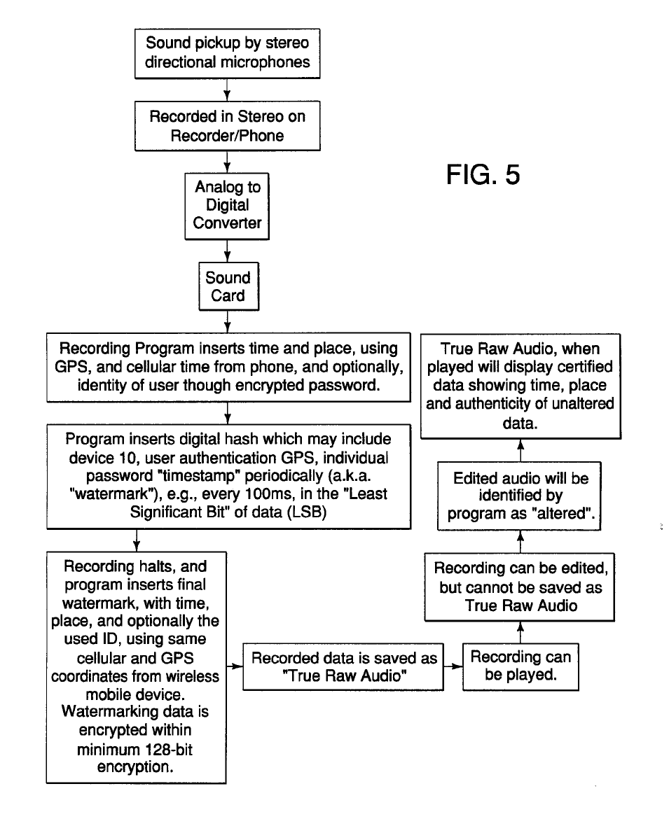

Another feature of device 10 this is that it allows for addition of substantial processing power to the smart phone. One issue with the smart phones as stated above is that they presently do not have enough available processing power to effectively allow editing of multi-track audio and certainly not video of any substantial quality. In the present invention and as illustrated diagrammatically in FIG. 4, the external device 10 includes its own central processing unit, including a processor with DSP, and sufficient RAM and storage, for example 512 MB or more of RM, and up to 32 gigabytes or more of memory, so as to have on-board to device 10 the ability to process the audio or video. A communication system including wireless interface 32 and/or USB interface 34 allows device 10 to communicate with the smartphone 28. The smart phone in its function as a remote control only sends editing decision information to external device 10. Very little processing happens on the smart phone itself. Thus for example once a user has edited a recorded piece by use of a small-screen (for example the 2 inch by 3 inch screen 18 on an IPhone™), it would then be saved. The edited piece may then be transmitted by the smart phone either by the cellular connection or Wi-Fi following which it could then be transmitted to the end destination.

Device 10 includes a separate battery (not shown) within the shaft, handle or bayonet 20 so as to not use the battery power needed by the smartphone, and to allow use of device 10 remote from the smartphone.

Firmware is written into device 10. In addition to making some audio processing decisions, the firmware includes the TRAC true audio certification which verifies whether the audio is unaltered or altered. One reason for putting the firmware into device 10 is that it is much harder to hack. Another reason is that separate software does not have to be written for every single device, that is for each type of smart phone and its corresponding device 10. Thus the TRAC verification process is included within device 10. Because extra processing power has been added within device 10 and linked to the smart phone, this allows video capture, and so a video camera 22 is included in device 10 capable of zooming in and out, and also of either doing auto focus or manual focus and doing that electronically. In the preferred embodiment camera 22 is mounted on a rotatable base 22a pivotally mounted to head 12 so that the camera may be pointed either towards or away from the user.

Thus video camera 22 may be either be flipped so it either points towards the person holding the smart phone, in other words so they can film themselves and see themselves on the screen of the phone, or the camera may be flipped to point the opposite way so that a subject which is some distance away may be recorded by the user while the user views the subject on the screen.

As discussed above, fifth microphone 14a is shielded from outside sound, but records the same RF and electromagnetic interference that the other microphones 14 are exposed to. The firmware subtracts the interference noise from the sound. The programming provides the ability to remove noise as needed. In post editing a user is able to select whatever noise occurs, that is from whatever source, and be able to subtract that noise. One example is sometimes known as notch filtering where a certain frequency is removed from the entire recording or portion of the recording. The four microphones are used in a phased array so as to be able to decide on the direction of the microphones and the noise cancellation. The phased array allows some noise cancellation in post production. For example, if there is a chainsaw being used behind the user while recording an interview, the user may later choose to eliminate a great deal of the chainsaw noise in post production.

The phased array is used by taking a base relationship of each individual microphone 14 as it relates to the others. This allows getting a beam and changing its directionality and width to eliminate noise. In addition to doing that directional component by changing the phase relationship, noise may be cancelled by calling mode rejection, which is attracting a noise very high in one part of the phasing relationship and very low in others.

One way the present invention is made to generically fit/function with smart phones is the use of an appropriate form factor. One drawback with devices presently coming on the market out now is that they have a form factor that essentially turns them into a holster. Applicants believe this is done because there is a certain amount of electronics that have to be inserted into a device to give it the audio processing necessary to get good quality. The problem with that is that if you actually put the electronics into the back of a holster, around the top or around the bottom or thereabouts they can interfere with the RF signal, and this has the effect interfering with for example transferring data by Wi-Fi or some other method, or may interfere with a user taking a phone call.

The present invention deals with the interference issue by using a different form factor. In one embodiment as described above device 10 has a long bayonet shaft 20 topped by head 12 in the shape of a hammer head. The bayonet shaft inserts into a slot or scabbard 30a in a cell phone case 30 that is especially made for a particular smart phone. Only the battery is in the bayonet shaft. When mounted in scabbard 30a the shaft is removed from enough away from the back of the phone so that it doesn't interfere with the transfer, whether a phone call or any other data transfer. Every style and make or model of phone on the market has its own form factor, so for example a conventional Alesis™ or Belkin™ holster style recorder only fits the particular phone style on which it is designed to mate. In particular, the Belkin™ and Alesis™ model that is made for an IPhone™, connects directly to the 30 pin port at the bottom of the IPhone™ so as to transmit its sound. It is made to hold an IPod-like phone. A user could not connect it to a Blackberry™ which connects via a USB port on the side of the phone. So if a user changes from an IPhone™ to a Blackberry™ the user would have to throw out the user's expensive recorder because it would become completely useless. The present invention eliminates the need for an electronic connection and instead substitutes a wireless connection through an improved form of 802.11 Wi-Fi connection. An optional USB connection may be provided. However, it is not required for the device to function. Without the need for an electronic connection, the ubiquity problem is addressed. The wireless device within head 12 detects how good the wireless connection is between the phone and the head.

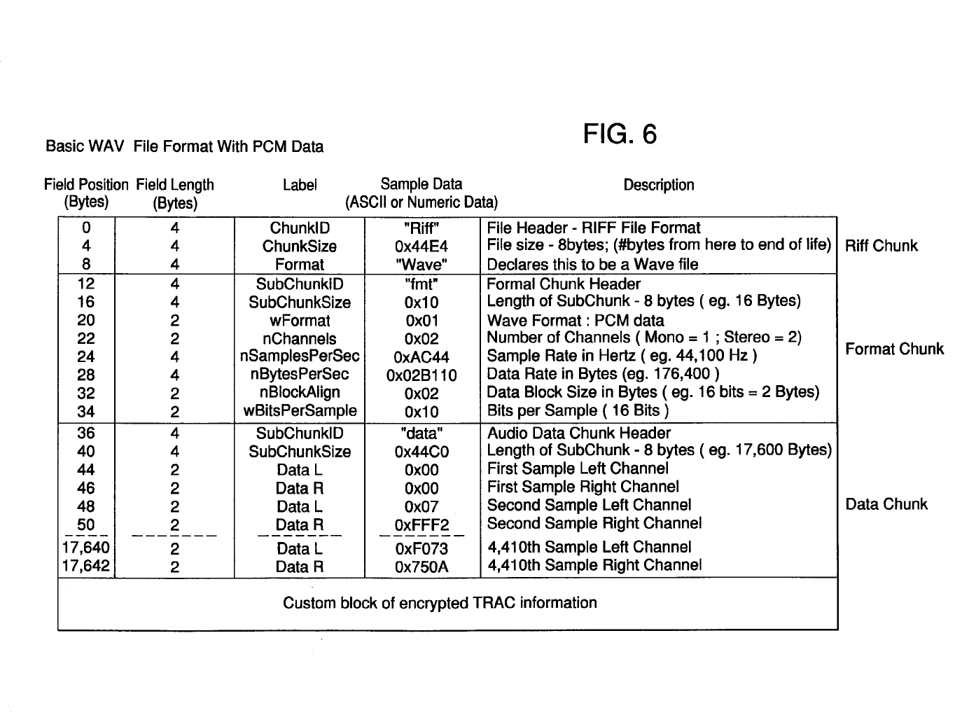

As seen in the accompanying flow diagram in FIG. 5, the use of the true raw audio certification may require that the handheld device 10 also include a global positioning system (GPS) locator capable of providing instantaneous GPS coordinates, and may also require an internal clock so that the certified time may be recorded along with certified GPS coordinates when the software is providing the true raw audio certification to the audio recording, or TRVC to the video recording where the hand held device 10 is also provided with an optical camera 22 and a corresponding video recording device within handheld device 10.

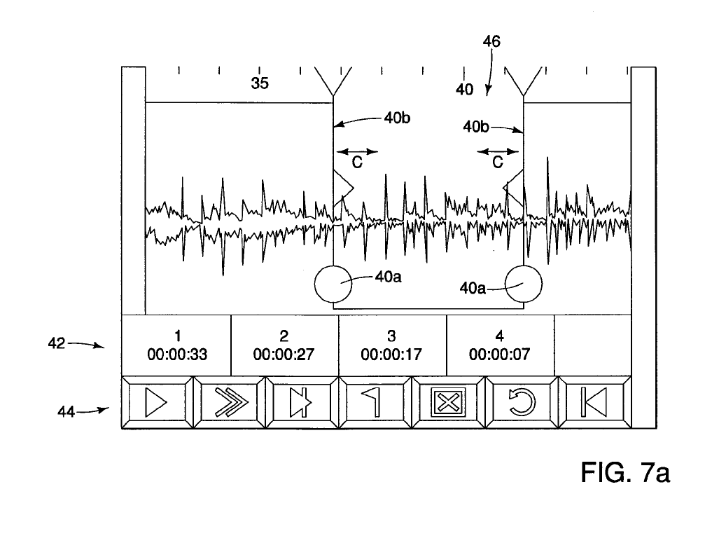

As seen in the screen capture of FIG. 7a, which is an enlarged view of touch screen 18 shown on phone 28 in FIG. 7, segments of detailed representations of recorded audio, such as shown by example in audio segments 40c, have been reduced to corresponding icons 40. A particular icon can be tapped to open the corresponding detailed segment across the width of the screen and then to be tapped to close the detailed segments. In this fashion details of a recording may be view one segment at a time, or details of segments placed adjacent to one another in a meaningful way on a small, for example 2 inch high by 3 inch wide, screen. The boundaries between portions within segments may be highlighted and moved, collapsed to an icon, or deleted using simultaneous touching by two finger tips applied to the screen 18. This may be done for example by pressing graphical pads 40a or vertical partitions 40b and sliding the partitions left or right in direction C. The detailed segments or portions of segments may be graphically moved relative to one another and rearranged using and moving the icons 40 across the lower graphical bar 42. Play, stop and edit command buttons 44 may be placed across the lower edge of the screen underneath bar 42. Graduated bar 46 indicates the time within the recording, and is displayed across the top of the screen.

Icons may be programmed to slide to the right along bar 42 when pulled by a user's finger contact with a particular icon in that direction. Once past the right side end of the sequence of icons 40, and then let go, that icon appears to elastically snap back into the right-most position on the right end of the sequence of icons. Similarly, numerous icons may be simultaneously slid and once let go appear to elastically re-join to the sequence of icons. When a segment of audio 41c is collapsed to an icon, that icon may then be dragged down by a finger slide onto the sequence of icons 40 along bar 42. That icon will then be inserted into the sequence at the position where it is left, and the remainder of the sequence to the right of that position adjusted to the right to accommodate the insertion of the new icon into the sequence. A further aspect of this design is that it envisages the user highlighting portions of audio or video, and them creating copies of those portions on the lower track, and then “dragging” those portions or clips into the desired position, relative to each other. In this way, unlike other audio or video editors, the user cannot, by accident or design, alter any portion of the original recording, thus preserving the ability to verify the authenticity of the digital record through the TRAC process. This editing system, provides for completely non-destructive editing, thus preserving the digital record. Combing this editing system with TRAC creates an easily achievable method of creating audio and/or video evidence that could used for example in a court of law.

### TRAC Embodiment

When a user selects the TRAC or TRVC of a recording, whether audio or video respectively being made by the handheld device, the certification software will annotate, mark or tag the recording at regular intervals, for example every one hundred milli-seconds, with the time and GPS coordinate information so that later play back of the recording will be documented and certified as being un-edited. In the event that the recording is edited, the certification software may annotate the edited recording as having been edited and the annotated GPS and time information will provide the details of what segments have been edited from the recording or rearranged within the recording period.

As stated above, one object of this invention, without intending to be limiting, is to provide a method to generate an audio recording that contains embedded meta-data so that it may be TRAC certified, for example so it that can be used to later validate and certify the integrity of the recording and to provide identifying information as to the time and location the recording was made, the identification code of the device that was used and optionally, an identification key of the person making the recording. A unique numeric data sequence is generated, referred to herein as a digital hash, using some of the identification data as a key and embedded into the audio data stream in a method that introduces an imperceptible amount of noise to the recording. Validation of the TRAC encoded audio file requires a TRAC-enabled audio editor/player, which validates the integrity of the file, displays the identification data, removes the numeric data stream and plays back the original, unaltered audio recording.

The audio file produced by this method is compatible with standard computer-based audio players and editors, which play, copy or edit the audio recoding, but not read the TRAC information or validate the integrity of the file. Any derivative of this file produced by a non-TRAC equipped editor will not contain valid TRAC meta-data but the audio data stream will carry the noise produced by the embedded numeric data stream. A TRAC-enabled editor will not validate such a derivative file.

The following description for creating the TRAC encoded audio file is based on creating a PCM-encoded WAV audio file that is commonly used in computers and portable audio recording devices.

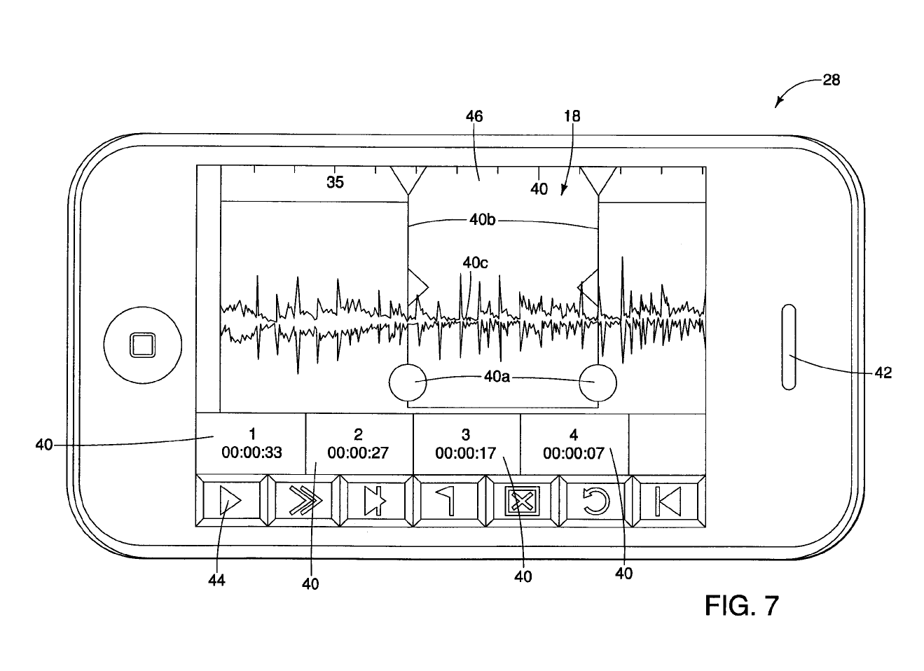

The WAV File illustrated in FIG. 6 corresponds to a basic canonical WAV file. The first section of the file is a RIFF Chunk that defines this file as being a WAV The second section of the file is the Format Chunk that defines the type of audio data encoding that was used to produce the recording and the specifications of the data format, sample rate, data rate and size of the data samples. The third section of the file is the actual data sample values in chronological sequence and interleaved by left channel first then right channel.

The audio data samples can be either contained in a single Data Chunk or they can be broken up into multiple Data Chunks, as long as they are positioned in the correct sequence in the WAV file. Additional Meta-data Chunks can also be incorporated into a WAV file as needed by the applications that are associated with this file type. In one embodiment not intended to be limiting, the present method uses some of the Meta-data Chunks that are currently defined by Microsoft™ Corporation: INFO List Chunk, Cue Chunk, Associate Data List Chunk, Label Chunk and Note Chunk. Additional Chunk types created for use with the invention are specified and registered with Microsoft™ as applicable and as the case may be.

Creating a data file that can be certified as a TRAC true audio recording consists of the following elements and procedures:

The first element needed to produce a certifiable audio recording is to embed the Date and Time of the recording into the data stream on a periodic basis (e.g. every 10 sec). The current Microsoft™ specifications recommend the use of a CUE Chunk in combination with Label and/or Note Chunks for this purpose. When the recording is started, a time stamp for example from the cellular transmission system and/or the global positioning system are recorded into a CUE Chunk, accurate to 0.01 s, along with a relevant entry entered in to the Note Chunk. As the recording proceeds, time stamps are periodically recorded (e.g. every 5 or 10 seconds) into the CUE Chunk along with appropriate entries in the Note Chunk. If the recording is paused and then restarted, corresponding Time stamps and Notes are entered into the file. When the recording is stopped, a final Time stamp and Note is recorded appropriately.

The second element needed to produce a certifiable audio recording is to embed location information about where the recording was made. This location information is checked periodically (e.g. once every minute), in case the recording was being made in a moving vehicle, train or airplane. Determining the location of the recording can be accomplished by combining information from all available geolocation information sources: such as embedded GPS circuitry; cell phone tower information; and WIFI Access Point mapping services. For example, SKYHOOK™ Wireless provides an on-line service that can determine the general location of a Wi-Fi connected device based on their mapping database of Wi-Fi routers and base stations across the USA. This combined location information can be stored in an Associated Data List Chunk and linked to appropriate Time stamps in the CUE Chunk.

The third element needed to produce a certifiable audio recording is to embed identification information about the person and/or device making the recording. This can be accomplished by a combination of several means that are available. First, record the MAC ID of the network interface circuit that is embedded in the recording device. Second, require a Login name and Password from the user in order to activate the TRAC functionality. Users can be required to create an account with a TRAC Licensing Agent website when they activate the software for the first time and obtain a User ID Code and a secure Private Encryption Key that must be downloaded to the TRAC-enabled recording device. The Private Encryption Key is used to encrypt identification data that is stored in a new TRID Chunk near the beginning of the file, and to create two encrypted Data Signatures that will be stored in a new TRAC Chunk at the end of the recording file, for later verification purposes.

When a TRAC-enabled recording is initiated, the recording software opens a new file and creates the RIFF and Format Chunks. It then creates an Info List Chunk with the User Name and ID Code, and basic Location and Time information in Clear Text (i.e. not encrypted) which can be read by non-TRAC-enabled devices. It then creates the TRID Chunk, and begins to record the detailed User ID, Device ID, Location, Time and Duration information for this recording. Additional information is added to the TRID Chunk at the end of the recording process.

The recording software then creates the first Data Chunk section (there may be more than one Data Chunk in a WAV file) and begins to record and store the audio data stream. The TRAC recording software concurrently builds data tables with the time stamp and location information that goes into the CUE, Note, Label and Associated Data List Chunks described above.

When the recording session is completed, the TRAC software closes the Data Chunk(s) and then creates and populates the CUE, Note, Label and Associated Data List Chunks. The software then adds record session duration and end time values to the TRID Chunk.

A Digital Signature of the audio recording is then generated by producing a Digital HASH computation for example, but not limited to, an MD5 or SHA-2 encryption algorithm, over the recorded audio data in the Data Chunk(s) and then encrypting the HASH value with the user's Private Encryption Key, or with a default TRAC system Key. The encrypted HASH value, which is a Digital Signature of the recorded audio data, is then stored as the first data value in the TRAC Chunk at the end of the file.

The TRAC software then calculates a Digital HASH value of the detailed Time, Location, Device and User ID data that is stored in the TRID Chunk. The data bit stream of this HASH values can then be used as a masking function to modulate the least significant bit (LSB) of selected audio data samples throughout the audio recording file. If the selected data bit of the HASH value is ‘1’ then the LSB of the audio sample will be inverted (i.e. ‘1’→‘0’; or ‘0’→‘1’). If the selected data bit of the HASH value is ‘0’, then the corresponding LSB of the audio sample will be left as-is. The bit stream from the HASH value would be repeated as needed until the end of the audio Data Chunk is reached.

Alternatively, in another embodiment of the present invention the HASH value may be used as Seed data for a Pseudo-Random Number Generator (PRNG), that would produce an extremely long, non-repeatable, bit stream sequence that may then be used to modulate the selected audio data LSBs.

Based on the sampling rate and number of channels in the audio data stream, the TRAC software calculates an appropriate modulation frequency that introduces a very low-level noise signal into the audio data. For example, modulating the LSB of every 511^{th} data sample in an audio file of 16 bit, stereo data, recorded at 44,100 samples per second, introduces a noise component of −96 db whose frequency is less than 44 Hz.

The TRAC software then adds information about the modulation technique used for this recording to the TRID Chunk and then encrypts that TRID Chunk with the user's Private Encryption Key, or with a default TRAC system Key.

The TRAC software then creates a HASH value for all of the data bytes of the entire WAV file from the first character of the RIFF Header up to the end of the first Data Signature in the TRAC Chunk. The software then encrypts this HASH value with the user's Private Encryption Key, or with the default TRAC system Key, and then stores this Digital Signature value as the second data entry in the TRAC Chunk.

The software then closes the file and reports the status to the user.

The TRAC recording file is now complete and ready to be used, stored or transmitted for further processing. The requirements for processing audio are also true of the video and these are accommodated in device 10. The video would be tied to the TRAC verification process similar to the TRAC of the audio so that the verification process applies to the video as well.

A TRAC-enabled Audio Editor or Player is able to identify that this file contains TRAC encoded data by the presence of the TRID Chunk. It then extracts the User ID from the Info Chunk and retrieves the user's Public Encryption Key from the TRAC Licensing Agent website.

The software then computes a digital hash of the whole file, and then uses the public key to extract the digital signature of the entire file from the TRAC chunk, and verifies that digital file is intact.

The Key enables the software to decrypt the TRID Chunk and extract the TRAC modulation information and recreate the HASH bit stream used to modulate the audio data. It then recalculates the Digital Signature of the original audio data, by reversing the modulation of the LSBs of the audio data, and compares the Digital Signature with the decrypted data from the TRAC Chunk. If they match then the software certifies that the record file is intact and authentic.

All of the detailed User, Device, Location and Time information may be used by the TRAC-enabled Editor to produce derivative audio recordings, or computer-generated transcripts, that identify where and when the original recording was made and by whom. The derived audio recordings contain information in the TRID Chunk that indicates that they are derivatives and not the complete original recording.

If a user loads a TRAC-encoded file in a non-TRAC-enabled editor, that person will not be able to extract the data in the TRID Chunk or the TRAC Chunk. They will not be able to detect or remove the modulated HASH data stream from the audio data samples. They will be able to read the Time and Location data in the CUE, Note and Associated Data List Chunks. They will be able to play the audio data and make derivative audio files from this file. However, any such edited or derivative file would no longer pass the certification test of a TRAC-enabled Editor or Player. The Digital Signatures stored in the TRAC Chunk would no longer match the data in the edited or derived WAV file.

The method described above can also be used for other audio recording formats and audio encoders, such as Mp3, AU, AAC, etc. This method can be adapted to various video recording formats as well such as MPEG 4, for example using the 4.264 video standard, as would be known to one skilled in the art.

True Raw Audio Certification and True Raw Video Certification are software programs designed to certify that sound and video recorded on a TRAC enabled device are true representations of what was recorded at the time the recording was made, and that they have not been altered or edited in any way. As already stated, the system uses a combination of the GMS time signal, the GPS signal, and the MAC address of the device to verify the recording. TRAC first embeds the date, time, and duration of the recording (accurate to 0.01 seconds) using the GMS cell signal. The time stamp will be embedded into the recording at the header segment, and then into the data stream at regular intervals—for example, every 100 milliseconds or so. The system embeds this metadata into the LSB. The device also records the ‘place’ of the recording by using the included GPS chip in the device. This data is embedded in the video and/or audio stream in the same way.

Finally, the data is further verified by having the MAC address of the device itself embedded in the data stream, ensuring that a user will know with certainty that a recording is made on the device in question, and not copied into another device.

The entire data stream is protected by 128 bit encryption for public usage, or (with government approval) higher encryption levels for law enforcement, government use, banking, and military, etc.

The end result is a recording that cannot be altered or copied without that fact being discovered. However, the system allows the user to edit the audio and/or video as they want, the resulting product then not being certified as “True Raw Audio”, or “True Raw Video”.

Editing the Audio Data on a Smart Recorder can be done later with un-modulated data to produce a clean derivative file, but editing the original recording on another piece of equipment will carry the modulation with it, and the HASH Signature will not match the data.

Conventionally, whatever quality is recorded is the end quality of the recorded product. For example, a reporter may be interviewing a person and decides in a particular story that only the voice of that person is wanted. However, later, the reporter decides that not only does the reporter want the voice of that person, but also the ambient noise around that person. If the reporter uses a directional microphone very close to that person, only their voice gets recorded and the reporter cannot go back later and pick up the ambient noise. In another example the reporter may decide to include more than one voice initially, and later decide that only one person's voice is wanted. Later on the reporter may realize that it is important that the reporter's question be put into the interview. Using the phased array of microphones approach according to the present invention, the reporter can change in post production what kind of sound decisions the reporter made earlier on. So if the reporter decides later that she wanted the voices of the both people in the interview she can change the sound envelope so as to include both people, or she may decide she only wants the one person in which case she can shape the sound envelope to only include the one person and improve the quality of that sound.

The phased microphone array improves the audio quality and also allows making decisions later in editing about how the audio is actually used. Frequently it is the case that while recording that a reporter may get an unwanted noise, so for example if the reporter recording under a fluorescent bulb or recording near a diesel truck or refrigerator, and the reporter doesn't notice that noise because it is ambient, often then the recordings are completely ruined. Using the present invention in post production process the reporter can shape the sound away from the unwanted sound source and thus greatly reduce it without the need to use something like a notch filter which will eliminate an entire frequency range of the audio. If a notch filter is used then the audio is degraded. Thus, being able to shape the sound in a post production process is important so as to get rid of unwanted sounds.

In the case of the IPhone™, using device 10 increases the amount of available RAM for example by 10-20 times what is available without device 10. This enables effective multi-track editing and also effective video editing. These are both processes that use a great deal of processing speed and power and a great deal of operational memory.

Another issue with mobile phones is what is actually on the operating system. In most cases audio processing or video processing ability is needed in the operating system itself. For example, there is a sub-operating system called core audio on the IPhone™ which allows for single track editing but does not allow for effective multi-track editing. This cripples the ability to do multi-track editing and the more tracks you add on the more difficult it is to do that processing on the IPhone™, and it may not even be possible. In the present invention multi-track editing is enabled because a DSP (digital signal processor) and the CPU is specifically designed for video and audio editing and includes an audio processor and CODEC (coder/de-coder) 36. A corresponding video processor 38 is also provided cooperating with CPU 24. Thus the present invention allows for multi-track editing, or for example having one video track and one or more audio tracks. The smart phone becomes the monitor and remote control for input of the functions for device 10. Thus for example as seen in FIG. 1, touch screen 18 contains a signal level indicator 18a which indicates by movement of a bar 18b on the like in direction B the input signal level (audio level), and also contains stop and pause/play icons 18c and 18d respectively.

In employing TRAC, the possibility of attempted hacking or fakery of a track file has to be addressed. Imagine if a user wanted to frame a person for murder. The user took a TRAC recording of the person and the user can now prove that it was unaltered because they have TRAC in the recording. Now the user wants to alter the recording and frame the person. What the user would be able to do under a different embodiment is to play that original file through high quality speakers and then have another recording device which would not have TRAC on it and record that audio. Once recorded that file, which would not have any TRAC embedded material in it, could be played through high quality speakers back into a TRAC device. The end result would be that a real TRAC recording where the geolocation data and temporal location data would be different from the original TRAC recording; that is, an authenticated TRAC recording which has been altered from the original recording.

One embodiment of the present invention prevents people from accomplishing this sort of deception. In this embodiment in addition to doing the digital encoding, an analog encoding or watermark is also done in the recording. A deterministic digital code is laid on top of an analog sound signal. It is embedded in the audio stream. In one scenario, you are a reporter and you don't need a really high level of security. The TRAC embodiment may then generate a sound with a digital code on top of it in the extremely high and extremely low registers of the audio signal, that is, beyond the range of normal human hearing. The TRAC device would detect that sound and if you tried to double it up by playing it back into another recorder you would also find that there would be certain harmonics that would occur when those two sounds crossed each other. The TRAC system would detect that there were two sets of these encoded sounds in the high and low band. However, a notch filter may be used to filter out the extreme high and extreme low end of the audio recording. The effect of that is that the recording would no longer have the high and low end. The absence of the high and low end might be detectable, but very likely could be explained as just a poor quality recording. It would be very difficult to detect that kind of filtering.

If a higher level of security is needed, for example in law enforcement, a variant noise determined by the TRAC generator would be run which could be read by the TRAC reader later. The variant noise would put a deterministic digital code on top of an analog signal, a sound. However in this embodiment the sound would be embedded in the in-band audio. On playback the human ear could hear this sound. Thus removing the sound could not be disguised. The sound could not be filtered out using a notch filter because it is within the range of the human voice and thus would be detected immediately, even by the human ear and certainly by the TRAC reader. The TRAC reader would detect right away the pattern that was removed and would immediately determine that the recording had been altered. So in addition to the earlier described digital encryption system an analog encryption may be added that ensures that the recording has not been altered by running it through different non-TRAC recording devices.

In one embodiment, the little audible sound generated might be characterized as a chirp, and not just in one particular frequency or band. The chirp may run right through the audible spectrum, probably at a very low volume level. For example, the chirp may run right through the most intelligible voice spectrum from 80 hertz right up to 3100 hertz. Thus the chirp is very difficult to remove, without completely removing everything that is within the audible spectrum.

Further, the chirp may be generated at random intervals determined by a pseudo random number (PRN) generator, and at random lengths, so that one chirp might be much shorter than another chirp for example as determined by the PRN generator. The effect is that it becomes virtually impossible to remove both the digital encryption and the chirp analog encryption.

The varying chirp lengths can be used to create binary data. For example, a short block of short chirp may be identified as, so as to correspond to a zero (0). A long chirp may then be a one (1). So depending on the pattern of short and long chirps a binary code may be embedded. The code may refer back to initial meta-data; that is, may also tell where and when and by whom the recording was recorded. So even if the digital encoding in the in-band noise is somehow removed, the in-band noise would indicate when and where the initial recording was done even if the digital information was hacked and altered to say the recording happened at a different time and place. This provides a double check. If that double check does not agree then the recording is not TRAC verified.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of recording audio or video data enabling true raw audio or true raw video certification, the method comprising the steps of:
a) recording on a mobile recorder an audio or video data stream taken from at least one microphone or camera respectively cooperating with said recorder,
b) generating a digital hash and embedding said digital hash in said data stream concurrently with said recording of said data stream,
c) enabling playback of said recording containing said digital hash by a playback device not equipped to decode said digital hash,
wherein said digital hash contain attributes unique to said recording and wherein said digital hash is embedded during said embedding in said data stream so as to minimize noise impact on a later audio or visual playback of said audio or video data stream respectively by said playback device, and wherein said digital hash is embedded during said embedding continuously on a periodic basis throughout the duration of said recording.

2. The method of claim 1 wherein said digital hash is embedded in a least significant bit of said data stream.

3. The method of claim 1 wherein said digital hash includes value representations of said attributes chosen from the group comprising a location of said recording, the time of said recording, the duration of said recording, an identification code of a device used to make said recording, the date of said recording.

4. The method of claim 3 wherein said digital hash includes meta-data.

5. The method of claim 4 wherein said meta-data are said value representations of said attributes.

6. The method of claim 3 wherein said groups further comprise a user identification of a user using said device.

7. The method of claim 5 wherein said digital hash is a unique numeric data sequence and where said attributes provide a key enabling said generating of said digital hash.

8. The method of claim 2 wherein said embedding of said digital hash introduces an audibly imperceptible amount of said noise to said recording.

9. The method of claim 3 wherein said recorder cooperatives with a cellular telephone and GPS circuitry and wherein at least said time of said recording is obtained from said telephone, and wherein at least said location of said recording is obtained from said GPS circuitry.

10. The method of claim 1 further comprising the steps of recording said attributes in a non-encrypted retrievable format in said recording so as to be retrievable by said playback device.

11. The method of claim 10 further comprising the steps of decoding said digital hash and determining status of certification said recording by comparing said recording of said attributes in said non-encrypted format with said attributes from said digital hash, wherein if said comparison determines no difference between both said attributes then certifying said recording as being an unaltered recording.

12. The method of claim 1 further comprising the step of breaking up said recording into a plurality of contiguous sequential segments and regenerating said digital hash for each segment in at least a sequential subset of said sequential segments.

13. The method of claim 1 further comprising the step of embedding an analog attribute into said recording continuously throughout said duration of said recording.

14. The method of claim 13 further comprising said embedding said analog attributes within an audible range in said recording.

15. The method of claim 1 further comprising the steps of providing a recording device that is adapted to work with different types of smartphone platforms, without the necessity of creating a physical, electronic point of connection for each of said different types of smartphone platforms.

16. The method of claim 1 further comprising reducing RF interference with audio recording in proximity to a mobile phone cooperating with said device by providing a shielded microphone and at least one non-shielded microphone for making said recording, and using the signal from said shielded microphone to filter said RF interference from said recording so to provide noise elimination.

17. The method of claim 16 wherein said at least one non-shielded microphone is a phased array of microphones and wherein an audio envelope is recorded by said phased array, and wherein said method further comprises the step of shaping said audio envelope.

18. The method of claim 1 further comprising the step of providing a phased array of microphones for said recording and separating said microphones from a mobile phone cooperating with said device by use of a form factor to minimize RF interference from said phone interfering with said device.

19. The method of claim 18 wherein said device and said phone are optionally directly electrically connected so as to reduce said interference.
